(19) United States
(12) Patent Application Publication
(10) Pub. No.: US 2023/0117190 A1
(43) Pub. Date: Apr. 20, 2023

(54) A CHROMATOGRAPHY DEVICE

(71) Applicant: Puridify Limited, Stevenage Hertfordshire (GB)

(72) Inventors: Anindya K. De, Bengaluru, Karnataka, NY (US); Anji Venna, Stevenage Hertfordshire (GB); Shameer Subratty, Stevenage Hertfordshire (GB); Adam Pinnock, Stevenage Hertfordshire (GB); Hannes Hjorter, Uppsala (SE); Lars Rosengren, Uppsala (SE); Klaus Gebauer, Uppsala (SE)

(21) Appl. No.: 17/904,190

(22) PCT Filed: Apr. 8, 2021
(86) PCT No.: PCT/EP2021/059126

§ 371 Date: Aug. 12, 2022

(30) Foreign Application Priority Data
Apr. 9, 2020 (IN) 202011015602

(51) Int. Cl. B01D 15/14; G01N 30/60; B01D 15/22; B01D 15/18; B01D 15/26

(52) U.S. Cl. CPC B01D 15/14; B01D 15/22; B01D 15/265; B01D 15/1871; G01N 30/6017; G01N 2030/027

(57) ABSTRACT

A chromatography device (201; 201′) comprising: – at least one chromatography material unit (203), wherein said chromatography material unit comprises a convection-based chromatography material and is of a substantially rectangular shape having a length (L) and a width (W); - at least one fluid distribution system (207) which is configured to distribute fluid into and out from the at least one chromatography material unit (203), wherein said fluid distribution system (207) comprises a distribution device (209a) and a collection device (209b) between which said chromatography material unit (203) is sandwiched, wherein said distribution device (209a) and said collection device (209b) each comprises a number of parallel grooves (255) for distribution and collection respectively of a fluid to be passed through the chromatography material unit (203), wherein said parallel grooves are reaching over substantially the whole length (L) of the chromatography material unit (203) and are distributed over substantially the whole width (W) of the chromatography material unit (203).

### TECHNICAL FIELD OF THE INVENTION

The present invention relates to a chromatography device comprising a convection-based chromatography material.

### BACKGROUND

Historically, conventional packed bed chromatography using porous beads has been an extremely powerful separation tool. In a porous bead-based system, the binding event between target molecule/impurity and the solid phase is dependent on diffusion into the porous bead. There is therefore a strong correlation between the interaction of molecules with the solid phase of porous bead-based systems and the residence time and thus the applied flow rate. Thus, binding capacity drops off with decreasing residence times. This type of chromatography can be called diffusion-based chromatography. A diffusion-based chromatography material includes any matrix which consists of particles and substantially exhibits a diffusion limitation of mass transfer, in that the rate of the adsorption and desorption processes is determined by the diffusion rate of the substance(s) into and out of the particles owing to the diffusion coefficients of the substance(s), which depend very heavily on the size, or the molecular weight, of the substances as well as the accessibility of the pores in the particles in terms of their size, structure and depth.

As alternatives to porous bead-based systems, monoliths or membranes may be used. The flow through such materials and the mechanism for molecules to interact with the solid phase is convective rather than diffusional, and their binding capacity is therefore far less sensitive to flow than porous bead-based systems. These materials can be run at far higher flowrates than porous bead-based materials. In (membrane) adsorption chromatography there is binding of components of a fluid, for example individual molecules, associates or particles, to the surface of a solid in contact with the fluid without the need for transport in pores by diffusion and the active surface of the solid phase is accessible for molecules by convective transport. The advantage of membrane adsorbers over packed chromatography columns is their suitability for being run with much higher flow rates. This is also called convection-based chromatography. A convection-based chromatography material includes any matrix in which application of a hydraulic pressure difference between the inflow and outflow of the matrix forces perfusion of the matrix, achieving substantially convective transport of the substance(s) into the matrix or out of the matrix and the surface of the matrix aimed for interaction with said substance(s), which is thereby effected very rapidly at a high flow rate.

Convection-based chromatography and membrane adsorbers are described in for example US20140296464A1, US20160288089A1, WO2018011600A1 and WO2018037244A1, hereby incorporated by reference in their entireties.

However, one problem with membrane adsorbers compared to porous beads is that the total surface area of the solid support accessible for interaction with the target molecules may be smaller. Hence binding capacities may be reduced, too. This is due to the fact that porous bead structures do provide high surface areas internal to the beads, hereby facilitating high binding capacities for substances small enough to access this porous structure by means of described slow diffusion mechanisms. In order to increase surface area and capacity with convection based membrane adsorbers and to compensate for the lack of area provided by diffusive pores, the size of convective pores in the membrane adsorber may be reduced. Hereby, a larger number of convective pores is achieved yielding a larger volume specific surface area of convective pores and thereby also larger total surface area accessible for interaction between substances and the matrix. Hereby, binding capacity of convective matrices can be significantly increased.

A result of smaller convective pores with membrane adsorbers, however, is an increased hydraulic resistance to flow compared to conventional packed beds. Yet, as membrane adsorbers can be configured to very short heights compared to packed beds, their increased hydraulic resistance may be compensated by a shorter height of the matrix. And advantage of membrane adsorbers is that they can, by design, realize a short height of the matrix, because the matrix consists from a continuous sheet of membrane material. This is a significant advantage compared to traditional chromatography beds packed from individual beads, which are limited to geometries and bed heights due to practical reasons in obtaining stable and homogeneous packed beds.

While membrane adsorbers can provide high throughput and binding capacities by means of their small convective pores, and while their high hydraulic resistance can be compensated by adsorber geometries with short height of the adsorber, it is the efficiency in distributing (and collecting) fluid across the inlet and outlet of the matrix that may be limiting overall performance. This is especially important at larger scale when liquid must be distributed and collected over matrices having large inlet and outlet areas.

One remaining problem with utilizing the advantages provided by convective matrices and membrane adsorbers is therefore the efficient distribution and collection of liquid and substances at the inlet and outlet surface of the matrix such that high chromatographic efficiency can be provided.

### SUMMARY

An object of the present invention is to provide an improved chromatography device comprising a convection-based chromatography material.

A further object of the present invention is to provide a chromatography device comprising a convection-based chromatography material which can allow high flow rates, withstand high operating pressures and withstand high internal loading for supporting the chromatography material at the desired material thickness.

A further object of the invention is to provide a chromatography device that can allow high flow rates, withstand high operating pressures, and withstand high internal loading for supporting the convection-based chromatography material at the desired material thickness in the single-use paradigm.

A further object of the invention is to provide a chromatography device allowing high chromatographic performance by efficient liquid distribution and collection that is uniform and simultaneous, hereby allowing a uniform flow through the chromatographic material and a uniform residence time distribution for substances passing the chromatography material.

A further object of the invention is to provide a chromatography device allowing high chromatographic performance by providing a device with low liquid holdup.

A further object of the invention is to provide a chromatography device with an improved liquid distribution and collection system that is easy to clean and sanitize.

This is achieved by a chromatography device according to claim 1.

According to one aspect of the invention a chromatography device is provided comprising:
at least one chromatography material unit, wherein said chromatography material unit comprises a convection-based chromatography material and is of a substantially rectangular shape having a length (L) and a width (W);
at least one fluid distribution system which is configured to distribute fluid into and out from the at least one chromatography material unit, wherein said fluid distribution system comprises a distribution device and a collection device between which said chromatography material unit is sandwiched;
an inlet;
at least one inlet fluid channel connecting the inlet with each chromatography material unit via the fluid distribution system;
an outlet; and
at least one outlet fluid channel connecting the outlet with each chromatography material unit via the fluid distribution system,
wherein said distribution device and said collection device each comprises a number of parallel grooves for distribution and collection respectively of a fluid to be passed through the chromatography material unit, which parallel grooves are in fluid connection with the inlet and the outlet respectively via an inlet common rail of the distribution device and an outlet common rail of the collection device, wherein said parallel grooves are reaching over substantially the whole length (L) of the chromatography material unit from a first end to a second end of the parallel grooves and are distributed over substantially the whole width (W) of the chromatography material unit and wherein said inlet and outlet common rails are fluid channels provided in a substantially perpendicular direction to the direction of the parallel grooves and which inlet and outlet common rails are in fluid connection with the first end of each of the parallel grooves.

Hereby a chromatography device is achieved allowing for high chromatography performance thanks to an efficient liquid distribution and collection that is uniform over the chromatographic material. One advantage of providing the parallel grooves for fluid distribution and collection across the chromatography material according to the invention is to provide efficient mechanical support to the chromatography material to withstand mechanical forces due to the pressure loss over the material exerted in the direction of flow, in addition to mechanical forces arising from support of the chromatography material at the desired thickness. This is achieved by having a large wall and contact area for the chromatography material in between the grooves, hereby distributing mechanical load over a surface area as large as possible and ensuring homogeneity and integrity of the chromatography material over a large number of load and pressure cycles.

Another advantage of providing the parallel grooves for fluid distribution and collection across the chromatography material according to the invention is that the liquid can be distributed and collected uniformly and simultaneously across the material. This is achieved by providing appropriate spacing and cross-sectional area of said parallel grooves.

Another advantage of providing the parallel grooves for fluid distribution and collection according to the invention is that said liquid distribution and collection can be achieved at lowest liquid holdup volume. This achieved by optimizing and modulating the geometry of the grooves in terms of width and depth.

Prior art distribution systems in chromatography typically exhibit distribution systems that provide tortuous flow paths, for example tortuous patterns of multiple grooves or similar, where liquid aimed for application to the chromatographic matrix may chose various and different travel paths for transport between inlet and outlet. The disadvantage with tortuous paths of prior art designs is that the overall holdup volume is necessarily larger than with the object of the invention. Another disadvantage with tortuous paths of prior art design is that the wall support area, i.e. the area not covered by open channels of the distributor, is necessarily smaller than according to the invention, hereby providing less mechanical support to the chromatographic matrix and allowing for less load and operating pressure than the invention.

In one embodiment of the invention said distribution device comprises a distribution plate which is provided abutting an inlet surface of the chromatography material unit, wherein said distribution plate comprises the parallel grooves for distributing a fluid feed provided from the inlet of the chromatography device to the chromatography material unit and wherein said collection device comprises a collection plate which is provided abutting an outlet surface of the chromatography material unit, wherein said collection plate comprises the parallel grooves for collecting a fluid from the chromatography material unit.

In one embodiment of the invention said parallel grooves each has a cross section area which is decreasing from the first end toward the second end.

In one embodiment of the invention said inlet and outlet common rails are provided reaching over substantially the whole width (W) of the chromatography material unit from a first end to a second end of the inlet and outlet common rail and wherein the inlet fluid channel is connected to the first end of the inlet common rail such that fluid is provided into the distribution device from a first corner of the fluid distribution system and wherein the outlet fluid channel is connected to the first end of the outlet common rail such that fluid is collected from the collection device from a second corner of the fluid distribution system, which second corner is diagonally opposite to said first corner.

In one embodiment of the invention the inlet common rail and the outlet common rail are provided along opposite side edges of the chromatography material unit.

In one embodiment of the invention said inlet common rail has a cross section area which is decreasing from a first end toward a second end of the inlet common rail.

In one embodiment of the invention a combined total area of a wall surface provided in between the parallel grooves in the distribution device/collection device and facing the chromatography material unit is larger than two times the combined total area of the grooves facing the chromatography material unit.

In one embodiment of the invention the parallel grooves each has a width being less than 1.5 mm and are spaced apart at more than 2 mm.

In one embodiment of the invention a holdup volume for the chromatography device is less than 1.6 times, such as 1.5 times, the membrane volume of the chromatography unit.

In one embodiment of the invention the outlet common rail has a larger fluid volume than the inlet common rail.

In one embodiment of the invention said chromatography device comprises at least one cassette, wherein each cassette comprises a fluid distribution system and a chromatography material unit.

In one embodiment of the invention said chromatography device comprises at least two cassettes which are stacked together and which cassettes each comprises a part of the inlet fluid channel which is in fluid connection with the inlet common rail provided in this cassette and which can be in fluid communication with the inlet of the chromatography device, possibly via one or more other cassettes of the chromatography device and which cassettes each comprises a part of the outlet fluid channel which is in fluid connection with the outlet common rail provided in this cassette and which can be in fluid communication with the outlet of the chromatography device, possibly via one or more other cassettes of the chromatography device.

In one embodiment of the invention said chromatography device further comprises a first end plate and a second end plate between which said at least two cassettes are provided, wherein said chromatography device further comprises locking members configured for locking the first and second end plates to each other.

In one embodiment of the invention said chromatography device further comprises an elastomeric sealing provided to an outer perimeter of the chromatography material unit for sealing against the distribution device and the collection device and surrounding said parallel grooves.

In one embodiment of the invention each chromatography material unit comprises at least one adsorptive membrane. In one embodiment of the invention said adsorptive membrane is a polymer nanofibre membrane.

In one embodiment of the invention each chromatography material unit comprises at least one adsorptive membrane sandwiched between at least one top spacer layer and at least one bottom spacer layer or at least two adsorptive membranes stacked above each other and interspaced with spacer layers and sandwiched between at least one top spacer layer and at least one bottom spacer layer.

### BRIEF DESCRIPTION OF THE DRAWINGS

FIG. 1 is an exploded perspective view of a chromatography device according to one embodiment of the invention.

FIGS. 2a and 2b show a first side and an opposite second side respectively of a distribution device or a collection device according to one embodiment of a distribution system which can be provided in a chromatography device according to the invention.

FIGS. 2c and 2d are cross sections along lines A-A and B-B respectively of the distribution device or the collection device as shown in FIG. 2a.

FIGS. 3a-3c show the chromatography device of the invention as shown in FIG. 1 as assembled, wherein FIG. 3a shows a front side or a back side of the assembled chromatography device and FIG. 3b is a cross section of the chromatography device along C-C of FIG. 3a and FIG. 3c is a cross section of the chromatography device along D-D of FIG. 3a.

FIG. 4a is a perspective view of a chromatography device according to another embodiment of the invention where a number of chromatography devices as shown in FIGS. 1 and 3a-3c have been assembled and connected in parallel.

FIG. 4b is a cross section of the chromatography device as shown in FIG. 4a.

FIG. 4c shows a part of the cross section in FIG. 4b in more detail.

FIG. 5a shows schematically flow paths in a chromatography device similar to the one shown in FIGS. 4a-4c where eight chromatography devices like the one shown in FIG. 1 and FIGS. 3a-3c have been connected in parallel.

FIG. 5b shows schematically flow paths in another chromatography device which is similar to the one shown in FIGS. 4a-4c where eight chromatography devices like the one shown in FIG. 1 and FIGS. 3a-3c have been connected in parallel.

FIGS. 6a and 6b show schematically in perspective a fluid distribution system according to another embodiment of the invention.

FIG. 6c shows schematically a perspective view of a fluid distribution system according to still another embodiment of the invention.

### DETAILED DESCRIPTION OF EMBODIMENTS

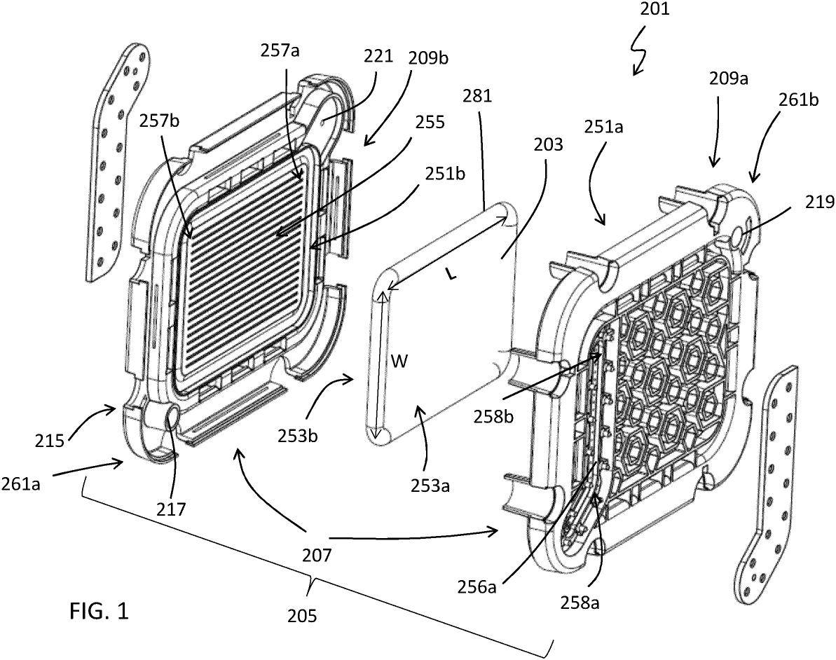

FIG. 1 is an exploded perspective view of a chromatography device 201 according to one embodiment of the invention. The chromatography device 201 comprises at least one chromatography material unit 203, wherein said chromatography material unit comprises a convection-based chromatography material. The chromatography material unit is suitably an axial flow device and can comprise flat sheet membrane material. The chromatography material unit is of a substantially rectangular shape having a length L and a width W. Substantially rectangular would mean that the chromatography material unit could have for example rounded or chamfered corners or curved side walls. Substantially rectangular may also comprise a chromatography material of a more oval form or in the form of a rhomb.

As discussed above a convection-based chromatography material can be for example an adsorptive membrane where a flow through such materials is convective rather than diffusional. The adsorptive membrane can for example be a polymer nanofibre membrane, such as for example cellulose, cellulose acetate and cellulose fibres which have been treated for use as an adsorbent. The adsorptive membrane could alternatively be a monolithic material or a conventional membrane made by emulsification.

Optionally, the adsorptive membrane comprises polymer nanofibers. The polymer nanofibers may have mean diameters from 10 nm to 1000 nm. For some applications, polymer nanofibers having mean diameters from 200 nm to 800 nm are appropriate. Polymer nanofibers having mean diameters from 200 nm to 400 nm may be appropriate for certain applications. Optionally, the polymer nanofibers are provided in the form of one or more non-woven sheets, each comprising one or more polymer nanofibers. Optionally, the adsorbent chromatography medium is formed of one or more non-woven sheets, each comprising one or more polymer nanofibers. A non-woven sheet comprising one or more polymer nanofibers is a mat of the one or more polymer nanofibers for each nanofiber oriented essentially randomly, i.e. it has not been fabricated so that the nanofiber or nanofibers adopt a particular pattern. Optionally, the chromatography material unit comprises one or more spacer layers. The spacer layers may be provided to add structural integrity to the adsorbent chromatography medium. In particular, the spacer layers may be more mechanically rigid than the non-woven sheets of nanofibers. The spacer layers can help to reduce deformation of the adsorbent chromatography medium during manufacture and/or use of the chromatography system to keep channels formed with the flow pates open. Ideally the spacer layer should be non-compressible, or largely non-compressible, to allow alternating layering of the compressible polymer nanofibers to allow porosity of this stack to be maintained at higher flowrates than if the compressible nanofibre was stacked alone. The format and composition of the spacer material is not particularly limited but should be more porous than the nanofibre layer and of minimal thickness to reduce dead volume in the stack. A suitable material would be non-woven polypropylene of 10-120 (grams per square meter).

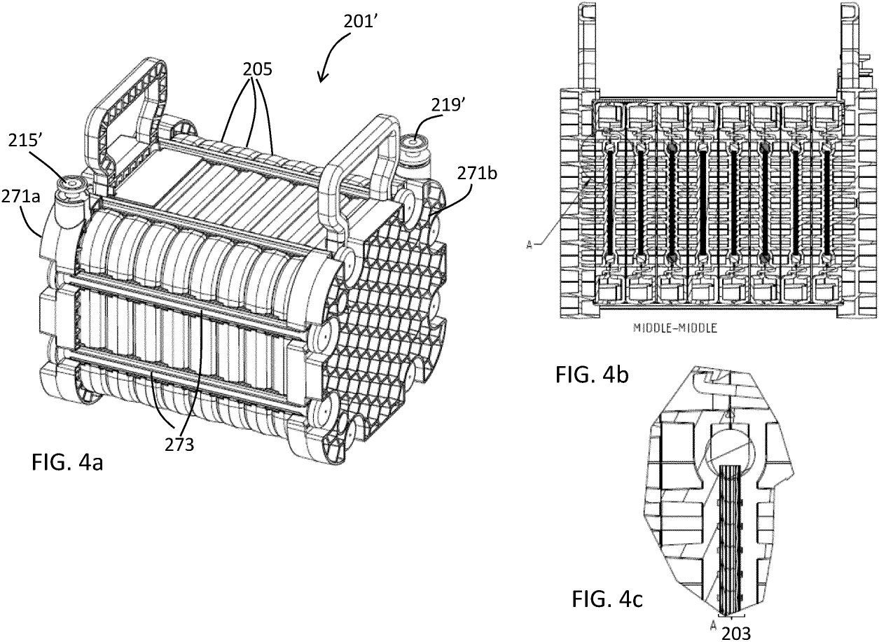

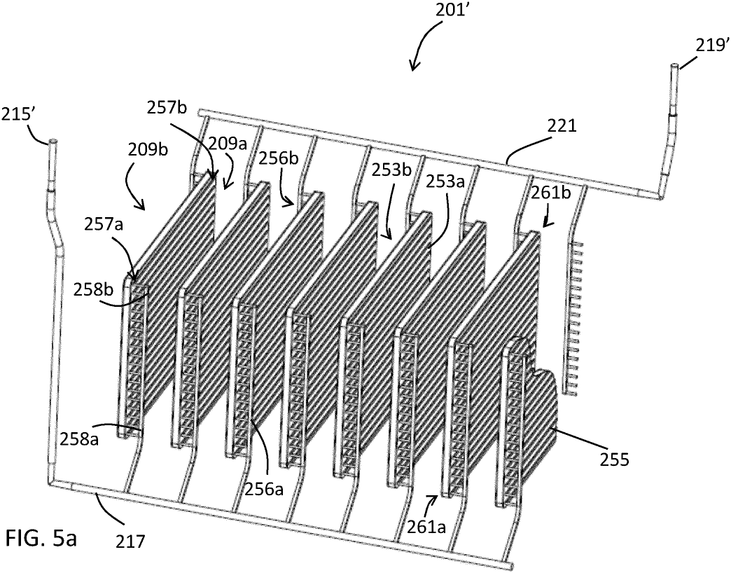

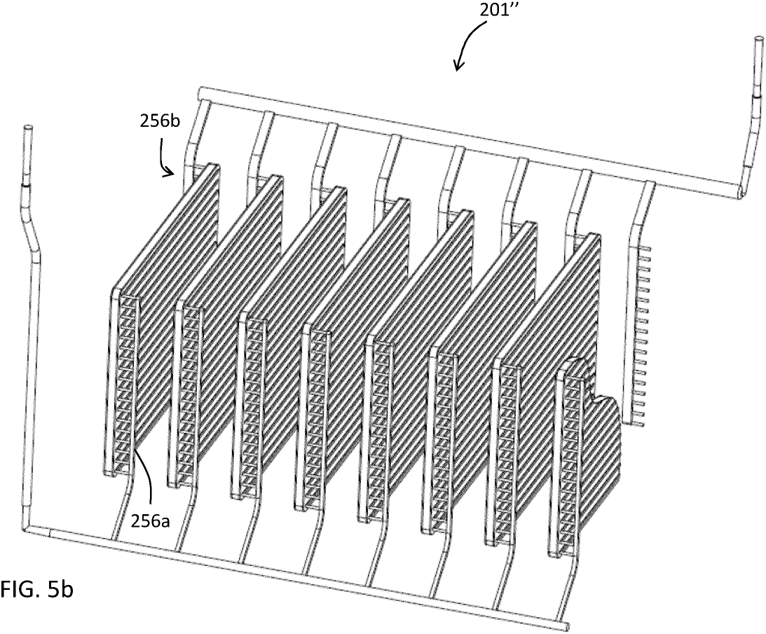

The chromatography device 201 according to the invention comprises furthermore at least one fluid distribution system 207 which is configured to distribute fluid into and out from the at least one chromatography material unit 203. In the embodiment of FIG. 1 only one chromatography material unit 203 is provided and one fluid distribution system 207. In FIGS. 4-5 a chromatography device 201′ comprising eight chromatography material units 203 and eight fluid distribution systems 207 are shown. Referring now to FIGS. 1-3, the fluid distribution system 207 comprises a distribution device 209a and a collection device 209b between which said chromatography material unit 203 is sandwiched.

In the case where the total number of any type of sheet in the chromatography material unit; spacer layer or chromatography material, is used, the chromatography material unit is sealed at or near the perimeter by an elastomeric sealing 281, such that a fluid connection between each sandwiched layer is formed without significantly affecting the surface area of the adsorbent material. A preferred embodiment of the chromatography material unit 203 comprises of a mechanically bonded (encapsulated form) elastomeric sealing 281 which acts to create a fluid connection between both the chromatography material unit 203 layers and the distribution device 209a and collection device 209b.

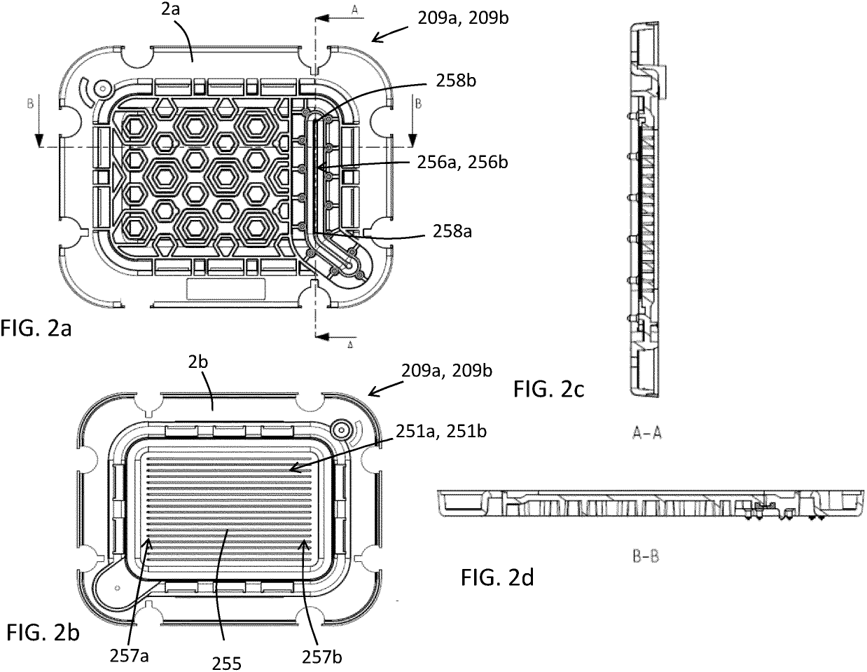

FIGS. 2a and 2b show a first side 2a and an opposite second side 2b respectively of a distribution device 209a or a collection device 209b according to one embodiment of a distribution system which can be provided in a chromatography device 201 according to the invention. The distribution device 209a and the collection device 209b can hereby be identical.

FIGS. 2c and 2d are cross sections along lines A-A and B-B respectively of the distribution device 209a or the collection device 209b as shown in FIG. 2a.

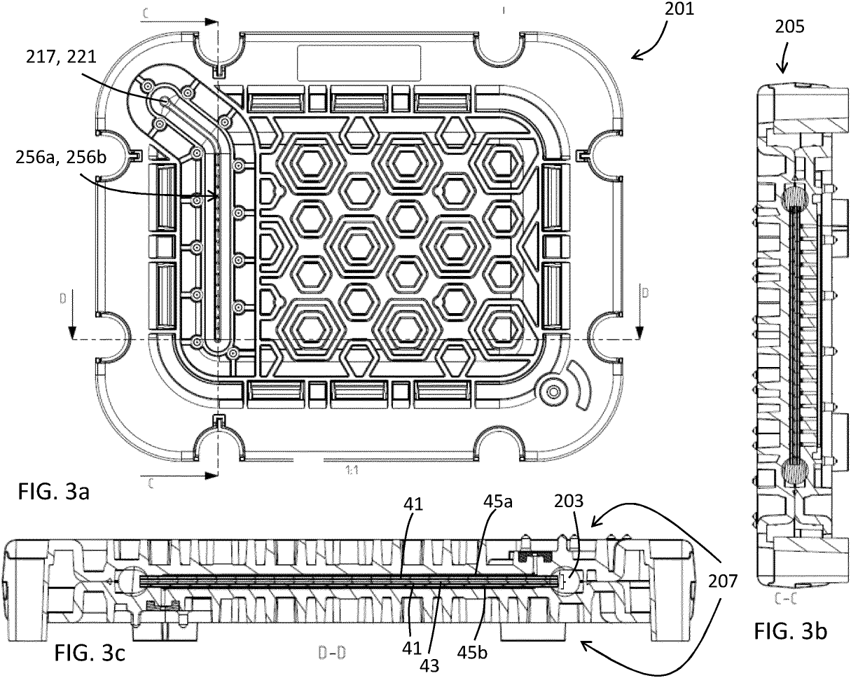

FIGS. 3a-3c show the chromatography device 201 of the invention as shown in FIG. 1 as assembled, wherein FIG. 3a shows a front side or a back side of the assembled chromatography device 201 and FIG. 3b is a cross section of the chromatography device 201 along C-C of FIG. 3a and FIG. 3c is a cross section of the chromatography device 201 along D-D of FIG. 3a.

The chromatography device 201; 201 comprises further an inlet 215; 215′ and an outlet 219, 219′. Referring to FIGS. 1-3 where only one chromatography material unit 203 and one fluid distribution system 207, which can be called one cassette 205, is provided the inlet and outlet are denoted 215 and 219 respectively and are connection ports into and out from the chromatography device 201 respectively. Referring to FIGS. 4-5 where eight cassettes 205 are stacked and connected in parallel in a chromatography device 201′ the inlet and outlet are denoted 215′ and 219′ respectively. The chromatography device 201, 201′ according to the invention comprises furthermore at least one inlet fluid channel 217 which is connecting the inlet 215; 215′ with each chromatography material unit 203 via the fluid distribution system 207 and at least one outlet fluid channel 221 connecting the outlet 219; 219′ with each chromatography material unit 203 via the fluid distribution system 207.

According to the invention said distribution device 209a and said collection device 209b each comprises a number of parallel grooves 255 for distribution and collection respectively of a fluid to be passed through the chromatography material unit 203. The parallel grooves 255 are in fluid connection with the inlet 215; 215′ and the outlet 219; 219′ respectively via an inlet common rail 256a of the distribution device 209a and an outlet common rail 256b of the collection device 209b. Said parallel grooves 255 can be reaching over substantially the whole length L of the chromatography material unit 203 from a first end 257a to a second end 257b of the parallel grooves 255 and are distributed over substantially the whole width W of the chromatography material unit 203. Over substantially the whole length L and substantially the whole width W can for example mean more than 80% or more than 90% of the whole length L and the whole width W. Suitably a distance between an outermost groove and an edge of the chromatography material is not longer than a distance between the grooves. And a distance between an end of a groove and an edge of the chromatography material unit can be about the same as a distance between grooves, e.g. 80-120% or 90-110% of a distance between grooves. Furthermore, if the chromatography material unit is not rectangular but instead more oval or has rounded corners some of the grooves, for example the grooves provided closer to an edge of the chromatography material unit, may be shorter than the rest of the grooves. Hereby all the grooves may not necessarily have the same length. In one embodiment, grooves are arranged such that they cover substantially the complete surface area of the chromatography material (e.g. at least 80%, such as at least 90% of the surface area) such that each and every position in surface area of the material is fed by a groove that is no further away from said position than the average distance of the grooves equidistantly spaced in the center of the distributor. In some embodiments, grooves may be applied in a curved or bended shape to accommodate a circumferential shape of the material deviating from a strict rectangular shape.

Said inlet and outlet common rails 256a, 256b are fluid channels provided in a substantially perpendicular direction to the direction of the parallel grooves 255 and which inlet and outlet common rails 256a, 256b are in fluid connection with the first end 257a of each of the parallel grooves 255. Substantially perpendicular can mean for example that a direction of the inlet and outlet common rails 256a, 256b are provided with an angle towards a direction of the parallel grooves 255 which angle is at least 80 degrees or at least 85 degrees. If, however the chromatography material unit is not rectangular but instead more oval the inlet and outlet common rails 256a, 256b may be somewhat bent following a bent edge of the chromatography material.

By providing parallel grooves distributed over substantially the whole surface area of the chromatography material unit 203 a fluid flow provided to the chromatography device for passing the chromatography material unit 203 can be distributed effectively over the whole area of the chromatography material unit 203. Furthermore, by providing substantially perpendicular inlet and outlet common rails connected to a first end of the parallel grooves the fluid flow can be effectively distributed to all the parallel grooves 255.

In some embodiments of the invention the parallel grooves 255 may each have a cross section area which is decreasing from the first end 257a toward the second end 257b. Hereby, the fluid flow may be more evenly distributed over the length, L, of the chromatography material unit 203, as residence time differences between fluid entering the chromatography material near the inlet/outlet common rail and fluid entering the material further away from the inlet/outlet common rail are reduced. The cross section of the groove is defined by the width of the groove representing the open fluid contact surface with the chromatography material and the depth of the groove. In some embodiments the groove is of rectangular shape. In other embodiments, the groove may have a rounded bottom surface. In some embodiments, the grooves may have cross section area decreasing from the first to the second end which is achieved by reducing the depth of the groove, by reducing the width of the groove or by combining a reduction in depth and width. In a suitable embodiment, the cross section of the grooves is reduced over their length by reducing the depth of the grooves.

By providing a chromatography device 201 with distribution and collection devices (209a, 209b) according to the invention providing parallel grooves for fluid distribution, a sanitary design is achieved that allows for efficient rinsing and cleaning of all wetted surfaces. Further, the fluid distribution system according to the invention allow for a cost efficient design and manufacturing of distribution and collection devices as the pattern of parallel grooves can be applied directly to the inner wall and surface of said devices during manufacturing, for example by injection molding.

With reference to FIG. 1, a chromatography device 201 according to one embodiment of the invention will now be described in more detail. The distribution device 209a comprises a distribution plate 251a which is provided abutting an inlet surface 253a of the chromatography material unit 203. The distribution plate 251a comprises the parallel grooves 255 for distributing a fluid feed provided from the inlet 215 of the chromatography device 201 to the chromatography material unit 203. The collection device 209b comprises a collection plate 251b which is provided abutting an outlet surface 253b of the chromatography material unit 203, wherein said collection plate 251b comprises the parallel grooves 255 for collecting a fluid from the chromatography material unit 203. Furthermore, said inlet and outlet common rails 256a, 256b are provided reaching over substantially the whole width, W, of the chromatography material unit 203 from a first end 258a to a second end 258b of the inlet and outlet common rails 256a, 256b. Over substantially the whole width, W, of the chromatography material unit 203 can mean for example over at least 80% or at least 90% of the whole width, W, of the chromatography material unit 203. The inlet fluid channel 217 is connected to the first end 258a of the inlet common rail 256a such that fluid is provided into the distribution device 209a from a first corner 261a of the fluid distribution system 207 and the outlet fluid channel 221 is connected to the first end 258a of the outlet common rail 256b such that fluid is collected from the collection device 209b from a second corner 261b of the fluid distribution system 207, which second corner 261b is diagonally opposite to said first corner 261a. The inlet common rail 256a and the outlet common rail 256b are provided along opposite side edges of the chromatography material unit 203. By introducing fluid to the distribution device 209a from a first corner 261a of the fluid distribution system 207 and collecting the fluid from the collection device 209b from a second corner 261b of the fluid distribution device 207, which second corner 261b is diagonally opposite said first corner 261a a uniform residence time for all fluid passing through the cassette 205 can be achieved. As an example, two different liquid elements passing through the cassette 205 at different positions will experience a similar total travel length and thereby residence time when summing up the total distance and volume that the fluid elements have to overcome for moving from inlet to outlet of the device. If the fluid instead would have been introduced to the distribution device 209a in a more central place, for example at the center of the inlet common rail, the overall travel path length for different fluid elements passing the cassette 205 at different positions would be different, thereby their residence time would be substantially different, too.

A uniform residence time for all fluid elements passing the device is advantageous to minimize the amount of liquid required to flush, rinse and clean the chromatography device and cassette 205 when applying a sequence of different fluids during a separation process. As an example, a uniform residence time allows a step change of a tracer substance at the inlet of the device resulting in an almost equally distinct and sharp step response signal at the outlet of the device. The sharper the step response signal at the outlet, the better binding capacity can be utilized, the more efficient fluid can be exchanged and the better the chromatographic efficiency overall.

In some embodiments of the invention said inlet common rail 256a can have a cross section area which is decreasing from a first end 258a toward a second end 258b of the inlet common rail 256a. Hereby the fluid flow can be better distributed over the distribution device 209a as the liquid holdup volume is reduced and residence time differences are reduced, resulting in a sharper signal response at the device outlet. Similarly said outlet common rail 256b can have a cross section area which is decreasing from a first end 258a toward a second end 258b.

Parallel grooves 255 in the distribution device 209a and the collection device 209b may have a width that is less than 1.5 mm. In one embodiment, parallel grooves have a width that is 1.2 mm or less. Hereby, the mechanical support and stabilization of the chromatography material unit 203 is optimized as the width and distance of unsupported area is minimized.

Parallel grooves 255 in the distribution device 209a and the collection device 209b may be spaced apart at more than 2 mm, and in some embodiments at more than 3 mm, hereby providing good mechanical support and stabilization of the chromatography material unit 203.

The combined total area of the wall surface facing the chromatography material unit 203 in between the parallel grooves 255 may be larger than two times the combined total area of the grooves 255 of the chromatography material unit 203. In one embodiment, the combined total area of the wall surface facing the chromatography material unit 203 in between the parallel grooves 255 may be larger than 3 times the combined total area of the grooves 255 of the chromatography material unit 203.

Prior art systems, with regard to grooves in distribution systems, often have networked distribution channels instead of the single (unidirectional) grooves according to the invention. A disadvantage of said prior art is that holdup volume is increased and support surface area for the matrix is reduced.

Another advantage with the grooves according to the invention is that liquid volume in the distributors can be minimized which reduces liquid holdup volume in the device. In one embodiment of the invention, the liquid volume in the complete device from inlet to outlet is less than 1.5 times the membrane volume (<1.5 MV).

In some embodiments of the invention the outlet common rail 256b has wider dimensions and is thereby of larger fluid volume than the inlet common rail 256a. This can be advantageous at larger device sizes where liquid flow in the common rail is fully turbulent. Such an embodiment is shown in FIG. 5b. An outlet common rail 256b having a larger fluid volume than the inlet common rail 256a will compensate for required build-up of dynamic pressure when collecting fluid exiting the cassette at a low velocity under laminar flow conditions and accelerating the fluid to high velocity and a turbulent flow regime. Hereby, the change in pressure and pressure loss in the common rail at inlet side can be matched with the change in pressure and pressure loss in the common rail at outlet side. By matching the pressure loss profiles in inlet and outlet common rails, a more uniform velocity of the fluid across the chromatography device can be achieved which results in a more uniform residence time distribution across the device and thus higher chromatographic efficiency.

The chromatography device 201; 201′ according to the invention comprises at least one cassette 205, wherein each cassette 205 comprises a fluid distribution system 207 and a chromatography material unit 203. In the chromatography device 201 as shown in FIGS. 1 and 3 only one cassette 205 is provided and in the chromatography device 201′ as shown in FIGS. 4-5 eighth cassettes 205 are provided. However, the number of cassettes 205 can of course be varied. If there are more than one cassette 205 provided the cassettes 205 can be stacked together as shown in FIGS. 4a-4c. Each cassette 205 comprises a part of the inlet fluid channel 217 which is in fluid connection with the inlet common rail 256a provided in this cassette 205 and which can be in fluid communication with the inlet 215, 215′ of the chromatography device 201; 201′, possibly via one or more other cassettes 205 of the chromatography device 201; 201. Each cassette 205) also comprises a part of the outlet fluid channel 221 which is in fluid connection with the outlet common rail 256b provided in this cassette 205 and which can be in fluid communication with the outlet 219; 219′ of the chromatography device 201; 201′, possibly via one or more other cassettes 205 of the chromatography device 201, 201′.

In a chromatography device 201′ comprising more than one cassettes 205 as for example shown in FIGS. 4a-4c, the chromatography device 201′ may further comprise a first end plate 271a and a second end plate 271b between which said at least two cassettes 205 are provided. Said chromatography device 201′ may further comprise locking members 273 configured for locking the first and second end plates 271a, 271b to each other. Sealings may be provided between the cassettes and between the outermost cassettes and the end plates 271a, 271b.

An elastomeric sealing 281 can be mechanically bonded to an outer perimeter of the chromatography material unit 203 creating a fluid connection between both the chromatography material unit 203 layers and the distribution device 209a and the collection device 209b when the cassette 205 is mounted. The elastomeric sealing 281 will be surrounding said parallel grooves 255. Said elastomeric sealing 281 will assure a sealed connection of the fluid distribution system 207 and the chromatography material unit 203 when the chromatography material unit 203 is sandwiched between the distribution device 209a and the collection device 209b of the fluid distribution system 207 over a range of separations between the distribution device 209a and the collection device 209b. Said elastomeric sealing 281 is in fluid connection with the distribution device 209a and collection device 209b surrounding said parallel grooves over a range of separation distances between the distribution device 209a and collection device 209b.

Each chromatography material unit 203 may comprise at least one adsorptive membrane. Said adsorptive membrane can be a polymer nanofibre membrane.

In some embodiments of the invention each chromatography material unit 203 may comprise at least one adsorptive membrane 41 sandwiched between at least one top spacer layer 45a and at least one bottom spacer layer 45b or at least two adsorptive membranes 41 stacked above each other and interspaced with spacer layers 43 and sandwiched between at least one top spacer layer 45a and at least one bottom spacer layer 45b. This can be seen in FIG. 3c. Top spacer layer 45a and/or bottom spacer layer 45b may be comprising one or multiple layers of spacer material which may be similar or different in properties, where main properties are porosity and hydraulic resistance. Where more than one of either adsorptive or spacer layers is present, the chromatography material unit 203 is sealed at or near the perimeter by an elastomer, such that a fluid connection between each sandwiched layer is formed without significantly affecting the surface area of the adsorbent material.

In one embodiment, said chromatography material unit 203 and said elastomeric sealing 281 are mechanically bonded for example by encapsulation.

In one embodiment, top spacer layer 45a and bottom spacer layer 45b are of significantly lower hydraulic resistance compared to the adsorptive membrane, thus creating lower pressure loss per unit length at a given flow rate. Hereby, a uniform lateral distribution of liquid from the grooves to the complete surface of the adsorptive membrane(s) is facilitated.

As can be seen in FIG. 5a the fluid flow through a chromatography device 201′ according to the invention can be provided such that the inlet fluid channel 217 first passes a chromatography material unit 203 for providing the fluid flow to the chromatography material unit 203 from a back side of the chromatography material unit. The fluid is thus collected from a front side of the chromatography material unit. As a result, the direction of fluid flow when passing through chromatography material unit 203 is opposite to the direction of fluid flow in inlet fluid channel 217 and outlet fluid channel 221. Thanks to this construction it is possible to decrease dead legs at the terminal ends of inlet and outlet fluid channels (X och Y). A conventional arrangement of a device with fluid application at the front side of the chromatography material unit, resulting in fluid flow passing through chromatography material unit 203 in the same direction as the direction of fluid flow in inlet fluid channel 217 and outlet fluid channel 221, would create larger dead legs and thereby require additional design elements and/or assembly steps during device manufacturing to plug said larger dead legs. This as dead legs are generally to be avoided as they represent pockets of fluid that are difficult to rinse and clean, hereby reducing overall chromatographic and process efficiency.

In one embodiment, chromatography device 201′ is provided pre-assembled (compare FIG. 4a) comprising one or several chromatography devices 201 and chromatography unit materials 203 sandwiched and locked in between a first and second end piece 271a, 271b such that a fluid tight assembly is obtained. In one embodiment, the locking is achieved by locking members 273 of fixed length, see FIG. 4a. In another embodiment, locking is achieved by locking members of adjustable length allowing to (re-)tighten and compress the assembly of the chromatography device 201′. In another embodiment of the invention, a locking means consisting of a snap or latch mechanism is provided for assembling and locking the chromatography device 201′ or parts of it against each other.

In one embodiment, chromatography device 201′ and its end pieces 271a, 271b are provided such that inlet 215 and outlet 219 are provided substantially on top of the device. Hereby, draining and/or loss of liquid from the device or spillage of liquid is minimized when connecting and/or disconnecting the device.

In one embodiment, the chromatography device 201′ is provided pre-sterilized, for example by gamma irradiation. The chromatography device, which is suitably a single-use device, can further be provided with aseptic connectors at inlet 215 and outlet 219 to allow for aseptic connection to a system, for example. Examples of such aseptic connectors are ReadyMate™ (Cytiva, formerly GE Healthcare Life Sciences) and Kleenpak™ (Pall). The pre-sterilized device can suitably be packed in double bags to facilitate entry into manufacturing cleanrooms.

In another embodiment, an external holder or clamping mechanism is provided, and chromatography device 201′ is fitted into said holder or clamping mechanism to enable further axial locking and/or compression of the end pieces 271a, 271b against each other in order to allow the device 201′ to withstand high fluid pressure and mechanical loading arising from supporting the chromatography material at the correct thickness without compromising device integrity and/or performance.

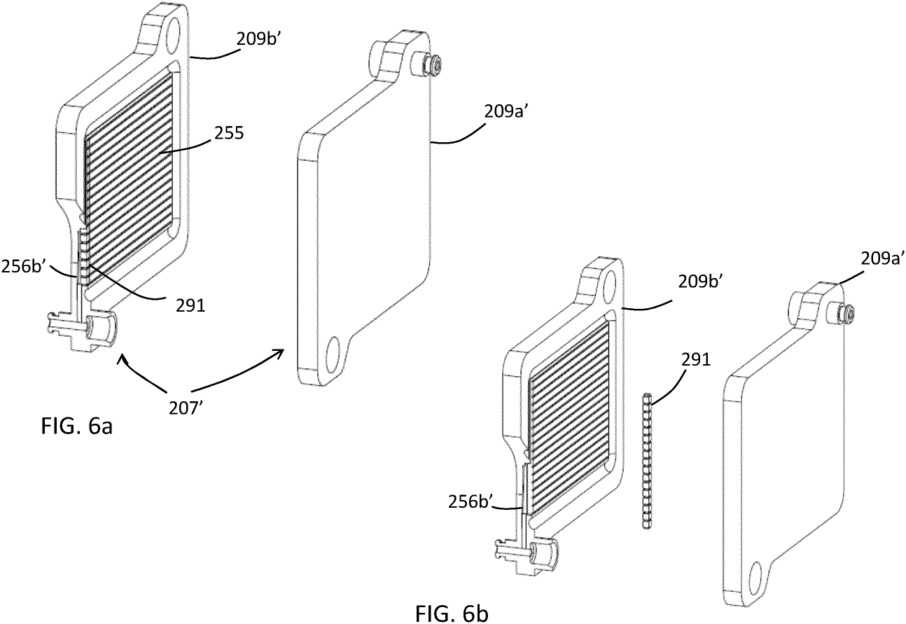

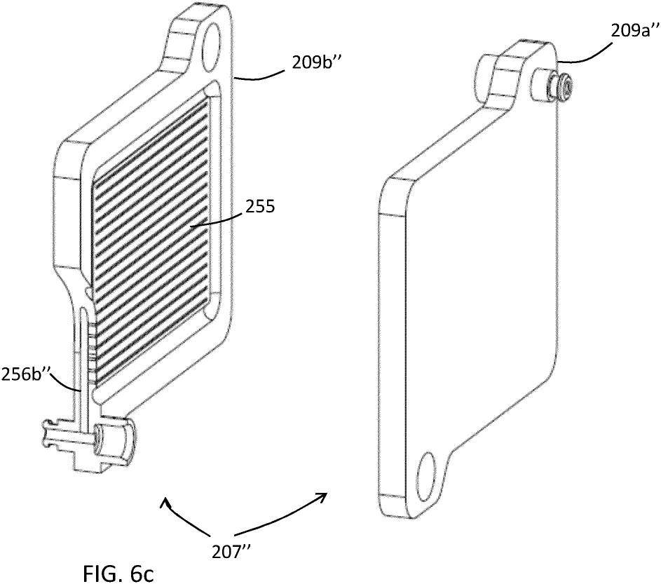

FIGS. 6a and 6b show schematically in perspective a fluid distribution system 207′ according to another embodiment of the invention. In this fluid distribution system 207′ an inlet/outlet common rail 256a′, 256b′ is provided from the same side of the distribution/collection device 209a′, 209b′ as the parallel grooves 255 are provided from (in contrast to the previously described embodiment shown in FIGS. 1-5, where the common rail 256a, 256b is provided to a first side 2a of the distribution/collection device 209a, 209b and the parallel grooves 255 are provided to a second and opposite side 2b of the distribution/collection device 209a, 209b). In this embodiment an insert 291 is needed for covering the common rail and providing openings between the common rail and the parallel grooves 255. The insert 291 is seen separated from the collection device 209b′ in FIG. 6b.

FIG. 6c shows schematically a perspective view of a fluid distribution system 207″ according to still another embodiment of the invention. In this embodiment the fluid distribution system 207″ is 3D printed and the inlet/outlet common rail 256a″, 256b″ is not provided from any of the sides of the distribution/collection device 209a″, 209b″ but instead provided as an internal groove within the distribution/collection device 209a″, 209b″. Fluid passages are also provided between the inlet/outlet common rail 256a″, 256b″ and each of the parallel grooves 255.

3D printing is one example of a possible production method for all embodiments and all details described above. Injection molding is another possible production method for some of the embodiments. In another embodiment, combinations of parts provided by 3D printing, injection molding or machining may be assembled to provide the devices according to the invention.

A part of the inlet fluid channel 217 in each of the cassettes 205 can in some embodiments comprise an elastomeric conduit sandwiched between the parts of the distribution device 209a and collection device 209b at the first corner 261a and a part of the outlet fluid channel 221 in each of the cassettes 205 can comprise an elastomeric conduit sandwiched between the parts of the distribution device 209a and collection device 209b at the second corner 261b, as means of fluid connection between the distribution device 209a and collection device 209b at the first and second corners. Wherein said elastomeric conduits are in fluid connection with the distribution device 209a and collection device 209b over a range of separation distances between the distribution device 209a and collection device 209b.

Facilitation of at least two states of operation for each cassette may be provided by combination of said elastomeric portions (conduit) of inlet fluid channel 217, outlet fluid channel 221, and said elastomeric sealing 281. For example, 1) a relaxed state, providing fluid connection between distribution device 209a and collection device 209b for low operating pressures and mechanical loading; preserving material properties of elastomeric seals by removing compression set effects for extended shelf life and 2) a compressed state, providing fluid connection between distribution device 209a and collection device 209b for high operating pressures and mechanical loading for achieving desired chromatography material unit 203 thickness.

1. A chromatography device comprising:
at least one chromatography material unit, wherein said chromatography material unit comprises a convection-based chromatography material and is of a substantially rectangular shape having a length and a width;
at least one fluid distribution system which is configured to distribute fluid into and out from the at least one chromatography material unit, wherein said fluid distribution system comprises a distribution device and a collection device between which said chromatography material unit is sandwiched;
an inlet;
at least one inlet fluid channel connecting the inlet with each chromatography material unit via the fluid distribution system;
an outlet; and
at least one outlet fluid channel connecting the outlet with each chromatography material unit via the fluid distribution system,
wherein said distribution device and said collection device each comprises a number of parallel grooves for distribution and collection respectively of a fluid to be passed through the chromatography material unit, which parallel grooves are in fluid connection with the inlet and the outlet respectively via an inlet common rail of the distribution device and an outlet common rail of the collection device, wherein said parallel grooves are reaching over substantially the whole length of the chromatography material unit from a first end to a second end of the parallel grooves and are distributed over substantially the whole width of the chromatography material unit and wherein said inlet and outlet common rails are fluid channels provided in a substantially perpendicular direction to the direction of the parallel grooves and which inlet and outlet common rails are in fluid connection with the first end of each of the parallel grooves.

2. The chromatography device according to claim 1, wherein said distribution device comprises a distribution plate which is provided abutting an inlet surface of the chromatography material unit, wherein said distribution plate comprises the parallel grooves for distributing a fluid feed provided from the inlet of the chromatography device to the chromatography material unit and wherein said collection device comprises a collection plate which is provided abutting an outlet surface of the chromatography material unit, wherein said collection plate comprises the parallel grooves for collecting a fluid from the chromatography material unit.

3. The chromatography device according to claim 1, wherein said parallel grooves each has a cross section area which is decreasing from the first end toward the second end.

4. The chromatography device according to claim 1, wherein said inlet and outlet common rails are provided reaching over substantially the whole width of the chromatography material unit from a first end to a second end of the inlet and outlet common rails and wherein the inlet fluid channel is connected to the first end of the inlet common rail such that fluid is provided into the distribution device from a first corner of the fluid distribution system and wherein the outlet fluid channel is connected to the first end of the outlet common rail such that fluid is collected from the collection device from a second corner of the fluid distribution system, which second corner is diagonally opposite to said first corner.

5. The chromatography device according to claim 1, wherein the inlet common rail and the outlet common rail are provided along opposite side edges of the chromatography material unit.

6. The chromatography device according to claim 1, wherein said inlet common rail has a cross section area which is decreasing from a first end toward a second end of the inlet common rail.

7. The chromatography device according to claim 1, wherein a combined total area of a wall surface provided in between the parallel grooves in the distribution device/collection device and facing the chromatography material unit is larger than two times the combined total area of the grooves facing the chromatography material unit.

8. The chromatography device according to. claim 1, wherein the parallel grooves each has a width being less than 1.5 mm and are spaced apart at more than 2 mm.

9. The chromatography device according to claim 1, wherein a holdup volume for the chromatography device is less than 1.5 times the membrane volume of the chromatography unit.

10. The chromatography device according to claim 1, wherein the outlet common rail has a larger fluid volume than the inlet common rail.

11. The chromatography device according to claim 1, wherein said chromatography device comprises at least one cassette , wherein each cassette comprises a fluid distribution system and a chromatography material unit.

12. The chromatography device according to claim 11, wherein said chromatography device comprises at least two cassettes which are stacked together and which cassettes each comprises a part of the inlet fluid channel which is in fluid connection with the inlet common rail provided in this cassette and which can be in fluid communication with the inlet of the chromatography device, possibly via one or more other cassettes of the chromatography device and which cassettes each comprises a part of the outlet fluid channel which is in fluid connection with the outlet common rail provided in this cassette and which can be in fluid communication with the outlet of the chromatography device possibly via one or more other cassettes of the chromatography device.

13. The chromatography device according to claim 12, wherein said chromatography device further comprises a first end plate and a second end plate between which said at least two cassettes are provided, wherein said chromatography device further comprises locking members configured for locking the first and second end plates to each other.

14. The chromatography device according to claims 1,further comprising an elastomeric sealing provided to an outer perimeter of the chromatography material unit for sealing against the distribution device and the collection device and surrounding said parallel grooves.

15. The chromatography device according to claim 1,wherein each chromatography material unit comprises at least one adsorptive membrane.

16. The chromatography device according to claim 15, wherein said adsorptive membrane is a polymer nanofibre membrane.

17. The chromatography device according to claim 1, wherein each chromatography material unit comprises at least one adsorptive membrane sandwiched between at least one top spacer layer and at least one bottom spacer layer or at least two adsorptive membranes stacked above each other and interspaced with spacer layers and sandwiched between at least one top spacer layer and at least one bottom spacer layer.
